(19) United States
(12) Patent Application Publication
(10) Pub. No.: US 2010/0231842 A1
(43) Pub. Date: Sep. 16, 2010

(54) Liquid Crystal Display Device

(75) Inventors: Tetsuji Ishitani, Atsugi (JP); Daisuke Kubota, Isehara (JP); Akio Yamashita, Atsugi (JP); Shuji Fukai, Atsugi (JP)

Correspondence Address: FISH & RICHARDSON P.C., P.O. BOX 1022, MINNEAPOLIS, MN, 55440-1022, US

(73) Assignee: SEMICONDUCTOR ENERGY LABORATORY CO., LTD., Atsugi-shi (JP)

(21) Appl. No.: 12/717,580

(22) Filed: Mar. 4, 2010

(30) Foreign Application Priority Data
Mar. 11, 2009 (JP) 2009-057764

(51) Int. Cl. G02F 1/1339

(52) U.S. Cl. 349/156

(57) ABSTRACT

To provide a liquid crystal display device in which a cell thickness (the thickness of a liquid crystal layer) having a certain value or more is secured, or to increase productivity of the liquid crystal display device. The liquid crystal display device includes a first substrate, a second substrate, a first spacer layer provided for the first substrate, a second spacer layer provided for the second substrate, and a liquid crystal layer including a liquid crystal between the first substrate and the second substrate, in which the thickness of the liquid crystal layer is controlled to be 6 μm or more and the birefringence Δn of the liquid crystal layer under a white display condition is 0.05 or less.

### BACKGROUND OF THE INVENTION

1. Field of the Invention

The technical field of the disclosed invention relates to liquid crystal display devices.

2. Description of the Related Art

In recent years, flat panel displays have been put to practical use and have been substituted for conventional displays using cathode-ray tubes. The flat panel displays include liquid crystal display devices which have liquid crystal display elements, EL display devices which have electro-luminescent elements (EL elements), plasma displays, and the like, and they come into competition in the market. At present, liquid crystal display devices establish a position of superiority by overcoming disadvantages and suppressing production cost with use of a variety of techniques.

The above-described liquid crystal display devices, however, are inferior to the other flat panel displays in a response time of an element (a speed of switching the display). Various techniques for overcoming the disadvantage in a response time have been proposed so far. A conventional liquid crystal element which employs a driving method of a liquid crystal called a twisted nematic (TN) mode has a response time of approximately 10 ms, whereas a liquid crystal element which employs an optical compensated birefringence (OCB) mode or a ferroelectric liquid crystal (FLC) mode has realized an improved response time of approximately 1 ms (see Patent Document 1 for example).

Another technique which attracts as much attention as these two driving methods of a liquid crystal applies a state called a blue phase to a liquid crystal display element (see Patent Document 2 for example). The blue phase is a liquid crystal phase which appears between a chiral nematic phase having a relatively short spiral pitch and an isotropic phase, and has a characteristic of an extremely high response time. With use of this blue phase, the response time of a liquid crystal display element can be 1 ms or shorter.

### REFERENCE

### Patent Document

[Patent Document 1] Japanese Published Patent Application No. H7-84254

[Patent Document 2] PCT International Publication No. 05/090520

The characteristics of the above-described blue phase liquid crystal are not only a high response time, but also a small birefringence Δn. The transmittance of a liquid crystal display device is generally expressed as a sine function like the following formula. The formula indicates that the thickness of an element with which a maximum transmittance is obtained is increased as the birefringence Δn becomes smaller. Note that λ represents a light wavelength (m), d represents a thickness of an element (m), and Δn represents a birefringence in the following formula.

$$T ∝ {sin}^{2} ( \frac{π Δ nd}{λ} ) \qquad [ Formula 1 ]$$

Liquid crystal display devices at present have an element thickness (a so-called cell thickness) of approximately 4 μm. Meanwhile, in the case of the blue phase, since the birefringence Δn of the liquid crystal under a white display condition is approximately 1/10, the most suitable cell thickness thereof can be approximately 10 times as large as the above-described cell thickness (approximately 40 μm). In consideration of a driving method, the cell thickness is preferably at least 6 μm or more (more preferably 10 μm or more). Note that the phrase “white display condition” means a condition where a maximum light transmittance of a target liquid crystal display device is obtained. In addition, the liquid crystal display devices using the blue phase are of a so-called normally black type, in which white is displayed by application of voltage.

Note that the cell thickness of the liquid crystal display device is controlled by a spacer which maintains a distance between an element substrate over which elements such as a thin film transistor are formed and a counter substrate. A well-known kind of the spacer is generally a spherical spacer or a columnar spacer.

In order to realize the above-described cell thickness with use of the spherical spacers, the diameter needs to be 6 μm or more. The use of such large spacers dispersed over a substrate is unpractical because of a high possibility of a display defect.

Further, also in the case of using the columnar spacers, it is difficult to make the thickness 6 μm or more. Since the columnar spacer is formed by selectively etching a resin layer which is formed by spin coating or the like, it is difficult to increase the viscosity of the material so as to make the resin layer thicker.

### SUMMARY OF THE INVENTION

In view of the above-described problems, an object of one embodiment of the disclosed invention in this specification and the like (including at least the specification, the claims, and the drawings) is to provide a liquid crystal display device in which the cell thickness (the thickness of a liquid crystal layer) having a certain value or more is secured. Alternatively, an object is to increase productivity of the liquid crystal display device.

In one embodiment of the disclosed invention, each of the two substrates included in a liquid crystal display device is provided with a columnar spacer, and the distance between the substrates (that is, the thickness of a liquid crystal layer) is controlled. For example, modes can be as follows.

A liquid crystal display device which is one embodiment of the disclosed invention includes a first substrate; a second substrate; a first spacer layer formed on the first substrate; a second spacer layer formed on the second substrate; and a liquid crystal layer including a liquid crystal between the first substrate and the second substrate, in which a thickness of the liquid crystal layer is controlled to be more than or equal to 6 μm by contact between the first spacer layer and the second spacer layer, and a birefringence Δn of the liquid crystal layer under a white display condition is less than or equal to 0.05.

A liquid crystal display device which is another embodiment of the disclosed invention includes a first substrate; a second substrate; a first spacer layer formed on the first substrate; a second spacer layer formed on the second substrate; and a liquid crystal layer including a liquid crystal between the first substrate and the second substrate, in which a thickness of the liquid crystal layer is controlled to be more than or equal to 6 μm by contact between the first spacer layer and the second spacer layer, and a Kerr coefficient of the liquid crystal layer is more than or equal to 1×10⁻⁹ mV⁻².

A liquid crystal display device which is another embodiment of the disclosed invention includes a first substrate; a second substrate; a first spacer layer formed on the first substrate; a second spacer layer formed on the second substrate; and a liquid crystal layer including a liquid crystal between the first substrate and the second substrate, in which a thickness of the liquid crystal layer is controlled to be more than or equal to 6 μm by contact between the first spacer layer and the second spacer layer, and the liquid crystal is driven by an electric field more than or equal to 3.0×10⁶ V/m under predetermined conditions.

A liquid crystal display device which is another embodiment of the disclosed invention includes a first substrate; a second substrate; a first spacer layer formed on the first substrate; a second spacer layer formed on the second substrate; and a liquid crystal layer including a liquid crystal between the first substrate and the second substrate, in which a thickness of the liquid crystal layer is controlled to be more than or equal to 6 μm by contact between the first spacer layer and the second spacer layer, a birefringence Δn of the liquid crystal layer under a white display condition is less than or equal to 0.05, and a Kerr coefficient of the liquid crystal layer is more than or equal to 1×10⁻⁹ mV⁻².

A liquid crystal display device which is another embodiment of the disclosed invention includes a first substrate; a second substrate; a first spacer layer formed on the first substrate; a second spacer layer formed on the second substrate; and a liquid crystal layer including a liquid crystal between the first substrate and the second substrate, in which a thickness of the liquid crystal layer is controlled to be more than or equal to 6 μm by contact between the first spacer layer and the second spacer layer, a birefringence Δn of the liquid crystal layer under a white display condition is less than or equal to 0.05, a Kerr coefficient of the liquid crystal layer is more than or equal to 1×10⁻⁹ mV⁻², and the liquid crystal is driven by an electric field more than or equal to 3.0×10⁶ V/m under predetermined conditions.

In description above, a surface area of the first spacer layer including a region in contact with the second spacer layer may be larger than a surface area of the second spacer layer including a region in contact with the first spacer layer.

Alternatively, the first spacer layer has a long side and a short side in a surface parallel to a main surface of the first substrate, the second spacer layer has a long side and a short side in a surface parallel to a main surface of the second substrate, and the first spacer layer and the second spacer layer may be in contact with each other so as to cross respective long sides. In this case, each length in the long-side directions of the first spacer layer and the second spacer layer may be shorter than a length in the short-side direction of a pixel.

In addition, in description above, a blue phase may be used as a liquid crystal phase. Further, the liquid crystal may be driven by an electric field in a horizontal direction (a direction parallel to a main surface of the first substrate) by being provided with a pixel electrode and a common electrode over the first substrate.

In one embodiment of the disclosed invention, it is possible to provide a liquid crystal display device in which a cell thickness of more than or equal to 6 μm is secured with use of a first spacer layer provided for a first substrate and a second spacer layer provided for a second substrate. Alternatively, with a suitable shape of the spacer layers, the productivity of the liquid crystal display device can be increased.

### BRIEF DESCRIPTION OF THE DRAWINGS

In the accompanying drawings:

FIGS. 1A and 1B illustrate a liquid crystal display device;

FIG. 2 shows a transmission spectrum;

FIGS. 3A to 3E are cross-sectional views illustrating a manufacturing process of a liquid crystal display device;

FIGS. 4A to 4D are cross-sectional views illustrating the manufacturing process of a liquid crystal display device;

FIG. 5 is a plan view illustrating a liquid crystal display device;

FIGS. 6A and 6B illustrate a liquid crystal display device;

FIGS. 7A and 7B illustrate a liquid crystal display device;

FIGS. 8A to 8D are cross-sectional views illustrating a manufacturing process of a liquid crystal display device;

FIG. 9 is a plan view illustrating a liquid crystal display device;

FIG. 10 is a plan view illustrating a liquid crystal display device;

FIGS. 11A1, 11A2, and 11B illustrate a liquid crystal display device;

FIG. 12 illustrates a liquid crystal display device;

FIGS. 13A and 13B illustrate a liquid crystal display device; and

FIGS. 14A to 14D illustrate electrodes of a liquid crystal display device.

### DETAILED DESCRIPTION OF THE INVENTION

Embodiments are described below in detail with reference to the drawings. Note that the present invention is not limited to the description of the embodiments, and it is apparent to those skilled in the art that modes and details can be modified in various ways without departing from the spirit of the present invention disclosed in this specification and the like. In addition, structures of different embodiments can be implemented in combination as appropriate. On the description of the invention with reference to the drawings, a reference numeral indicating the same part is used in common throughout different drawings, and repeated description is omitted.

### Embodiment 1

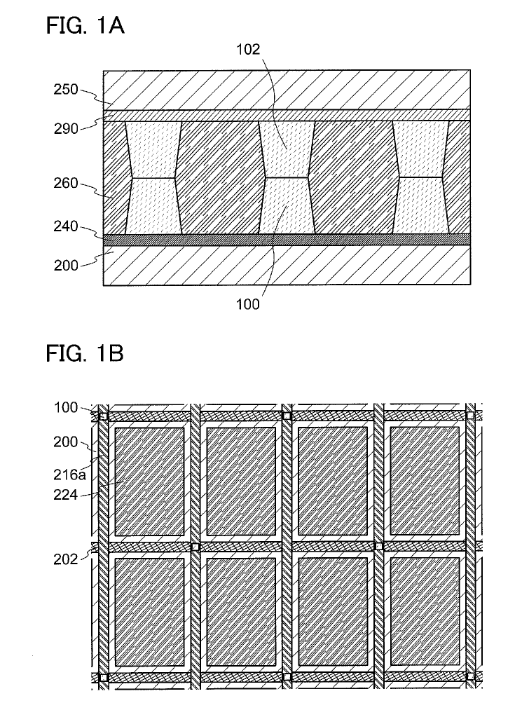

In this embodiment, a liquid crystal display device which is one embodiment of the disclosed invention is described with reference to FIGS. 1A and 1B. Note that the structure illustrated in FIGS. 1A and 1B is only an example, and therefore, another structure may also be employed.

FIGS. 1A and 1B are a cross-sectional schematic view and a plan schematic view of the liquid crystal display device which is one embodiment of the disclosed invention, respectively.

In the liquid crystal display device described in this embodiment, the distance between a first substrate 200 and a second substrate 250 is maintained by a first spacer layer 100 and a second spacer layer 102 (see FIG. 1A). More specifically, a surface of the first spacer layer 100 which is substantially parallel to a main surface of the first substrate 200 and a surface of the second spacer layer 102 which is substantially parallel to a main surface of the second substrate 250 are in contact with each other, and consequently, the distance between the first substrate 200 and the second substrate 250 are maintained. In other words, the total height of the first spacer layer 100 and the second spacer layer 102 are approximately equal to the thickness of a liquid crystal layer 260.

Although there is no particular limitation on the height of the first spacer layer 100 and the height of the second spacer layer 102, it is preferred that the height of the first spacer layer 100 and the height of the second spacer layer 102 satisfy a required cell thickness in order to secure a desired cell thickness (the thickness of the liquid crystal layer 260). For example, since a cell thickness of 6 μm or more (preferably, 10 μm or more) is required in the case of a liquid crystal display device using a blue phase, the height of the first spacer layer 100 and the height of the second spacer layer 102 may be 4 μm or more (preferably, 5 μm or more) each. The height of the first spacer layer 100 and the height of the second spacer layer 102 are not necessarily equal because the cell thickness is determined by the combination of the first spacer layer 100 and the second spacer layer 102. That is, it is acceptable as long as the total height of the first spacer layer 100 and the second spacer layer 102 is 6 μm or more (preferably, 10 μm or more). Note that the range of values is an example in the case of using a blue phase, and therefore, one embodiment of the disclosed invention is not limited thereto.

A layer 240 which includes a pixel electrode and a semiconductor element is provided for the first substrate 200, and a layer 290 which includes a common electrode (also referred to as a counter electrode) is provided for the second substrate 250. Needless to say, position of each component is not limited to the above description, but can be changed as appropriate as needed. For example, the layer 290 including the common electrode may be formed on the first substrate 200 side, and the layer 240 including the pixel electrode and the semiconductor element may be formed on the second substrate 250 side. In the case of manufacturing a liquid crystal display device using a horizontal electric field, the layer 240 may include the common electrode and the layer 290 may be omitted. In this manner, there is no particular limitation on structures of the layer 240, the layer 290, and the like as long as a liquid crystal display device is realized.

An insulating layer covering the layer 240 and the first spacer layer 100, and/or an insulating layer covering the layer 290 and the second spacer layer 102 may be formed. In this case, each component described above and the liquid crystal layer 260 are individually separated by the insulating layer. This insulating layer may have a function of liquid crystal alignment.

The first spacer layer 100 and the second spacer layer 102 are formed by selectively etching insulating layers. Materials of the insulating layers include the following: an organic resin material containing acrylic, polyimide, polyimide amide, epoxy, or the like as its main component; an inorganic material containing oxygen, nitrogen, silicon, and/or the like (e.g., silicon oxide, silicon nitride, silicon oxide containing nitrogen); or the like. Note that the formation method of the first spacer layer 100 and the second spacer layer 102 is not limited to the description above. For example, a method for selectively forming an insulating layer, such as a screen printing method or an inkjet method may be employed so that the first spacer layer 100 and the second spacer layer 102 are formed.

The first substrate 200 and the second substrate 250 can be made of glass, metal (typically stainless steel), ceramics, plastic, or the like. Note that one embodiment of the disclosed invention is not limited thereto. Another substrate may also be used as long as a liquid crystal display device can be realized.

There is no particular limitation on components of the layer 240 and the layer 290 either. For example, a thin film transistor using a semiconductor material containing silicon, germanium, or the like as its main component can be used as the semiconductor element in the layer 240. Alternatively, a so-called oxide semiconductor material or an organic semiconductor material may be used for the semiconductor element. There is no particular limitation on components of the pixel electrode and the common electrode either. For example, the pixel electrode and the common electrode can be formed using a light-transmitting conductive material such as indium oxide containing tungsten oxide, indium zinc oxide containing tungsten oxide, indium oxide containing titanium oxide, indium tin oxide containing titanium oxide, indium tin oxide (hereinafter also referred to as ITO in some cases), indium zinc oxide, or indium tin oxide to which silicon oxide is added. In the case of a liquid crystal display device using a horizontal electric field, or a reflective or transflective liquid crystal display device in which a light-transmitting property is not needed for a pixel electrode or a common electrode, an electrode material such as aluminum (Al), tungsten (W), titanium (Ti), tantalum (Ta), molybdenum (Mo), nickel (Ni), platinum (Pt), copper (Cu), gold (Au), silver (Ag), manganese (Mn), neodymium (Nd), niobium (Nb), chromium (Cr), cerium (Ce), or the like can be used as appropriate.

The liquid crystal layer 260 includes a liquid crystal material. It is preferred that, for example, the liquid crystal material be a liquid crystal material exhibiting a blue phase, which is superior in a response time. The liquid crystal material exhibiting a blue phase preferably includes a chiral agent in addition to a liquid crystal. The blue phase can appear easily with the use of a liquid crystal material into which the chiral agent is mixed at 5 wt % or more, for example. Note that the liquid crystal material is not limited to the above-described material. It is possible to select and use a liquid crystal material containing thermotropic liquid crystal, low molecular liquid crystal, high molecular liquid crystal, ferroelectric liquid crystal, anti-ferroelectric liquid crystal, or the like, as appropriate. In addition, there is no particular limitation on a liquid crystal phase to be used either; it is possible to use a cholesteric phase, a cholesteric blue phase, a smectic phase, a smectic blue phase, a cubic phase, a chiral nematic phase, an isotropic phase, or the like, as appropriate.

In a liquid crystal display device described in this embodiment, the first spacer layer 100 is formed so as to be a square or an approximate square when seen from a direction perpendicular to a main surface of the first substrate 200 (see FIG. 1B); however, one embodiment of the disclosed invention is not limited thereto. The reason is that there is no particular limitation on the shape of the first spacer layer 100 as long as the cell thickness can be maintained by combination with the second spacer layer 102. The same can be applied to the second spacer layer 102. Note that part of components such as the second substrate 250 is omitted in FIG. 1B so that one embodiment of the disclosed invention can be understood easily.

FIG. 1B illustrates a conductive layer 202 serving as a scan line, a conductive layer 216a serving as a signal line, and a conductive layer 224 serving as a pixel electrode, as typical components to be included in the layer 240 (see FIG. 1A); however, one embodiment of the disclosed invention is not limited thereto. In addition, there is no particular limitation on the shape or the like of the conductive layer 202 serving as the scan line, the conductive layer 216a serving as the signal line, and the conductive layer 224 serving as the pixel electrode either.

In FIG. 1B, the first spacer layer 100 and the second spacer layer 102 are formed in a region where the conductive layer 202 serving as the scan line and the conductive layer 216a serving as the signal line are crossed; however, one embodiment of the disclosed invention is not limited to the structure. In the case of forming a black mask (a black matrix) having a light-shielding function, the first spacer layer 100 and the second spacer layer 102 may be formed in a region which overlaps with the black mask.

As described in this embodiment, with the use of the first spacer layer provided for the first substrate and the second spacer layer provided for the second substrate, it is possible to provide a liquid crystal display device in which a cell thickness of 6 μm or more (preferably, 10 μm or more) is secured. As a result, display characteristics can be improved also in a liquid crystal display device whose cell thickness needs to be large (e.g., a liquid crystal display device using a blue phase with a birefringence Δn of 0.05 or less under a white display condition, or a liquid crystal display device whose liquid crystal layer has a Kerr coefficient of 1×10⁻⁹ mV⁻² or more). Note that the phrase “white display condition” in this specification and the like means a condition where a maximum light transmittance of a target liquid crystal display device is obtained. In addition, the Kerr coefficient K (mV⁻²) is defined by the following formula. In the formula, λ represents a wavelength of light (m), E represents an electric field (m⁻¹V), and Δn represents a birefringence.

Δn=KλE² [Formula 2]

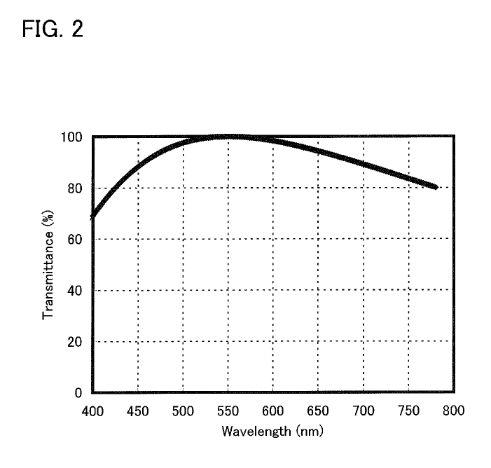

FIG. 2 shows a transmission spectrum in the case where Δnd is 0.275 μm under the white display condition (the condition where a maximum transmittance is obtained at a wavelength of 550 nm: the condition satisfying Δnd=λ/2) as an example of an optimal condition of a liquid crystal display device. In FIG. 2, the horizontal axis indicates a wavelength of light (nm) and the vertical axis indicates transmittance (%). In this case, for example, it is understood that when the birefringence Δn is 0.04, the optimal cell thickness is approximately 6.9 μm. In an opposite manner, when the cell thickness is able to be 10 μm, the birefringence Δn may be approximately 0.03. This indicates that, in the case of a liquid crystal display device using a blue phase with a birefringence Δn of 0.05 or less, it is preferred that the cell thickness be approximately 6 μm or more.

Note that in the case of using a blue phase, high-electric-field driving is needed because of its characteristics. For example, under predetermined conditions, driving with an electric field of 3.0×10⁶ V/m or more can be performed in some cases. Such high-electric-field driving is particular to a liquid crystal display device using a blue phase. An example of the above-described predetermined conditions is the white display condition. Under the white display condition, a higher electric field generates between electrodes as compared to the case where another gray scale is displayed.

The structures, methods, or the like described in this embodiment can be implemented in combination with another structure, method, or the like described in another embodiment, as appropriate.

### Embodiment 2

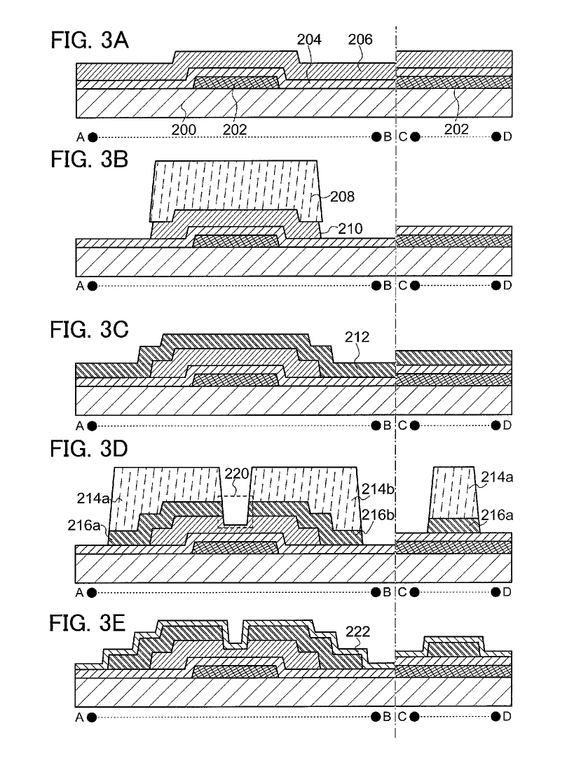

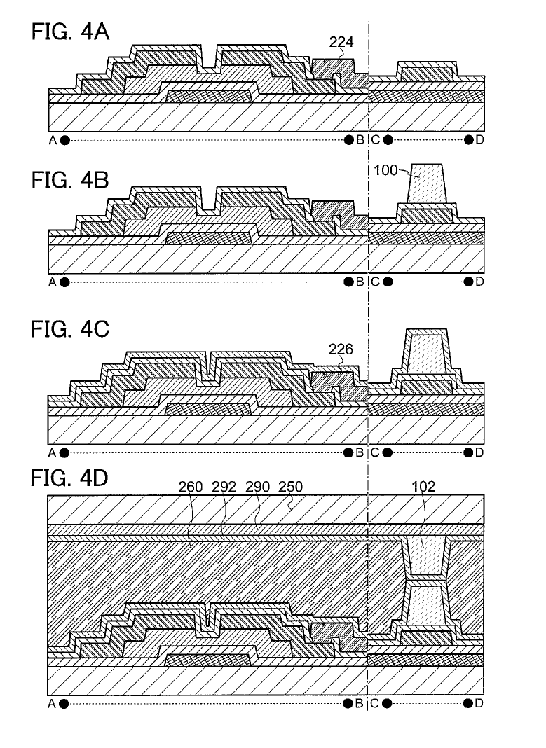

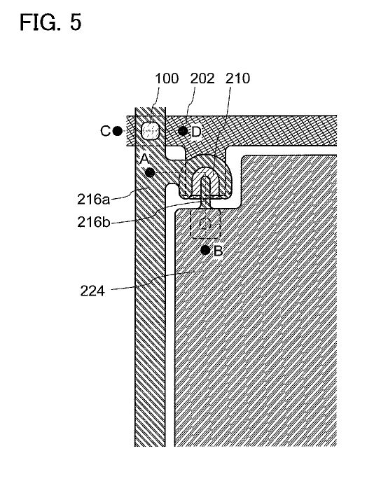

In this embodiment, a method for manufacturing a liquid crystal display device which is one embodiment of the disclosed invention is described with reference to FIGS. 3A to 3E, FIGS. 4A to 4D, and FIG. 5. Here, cross sections taken along lines A-B and C-D in FIG. 5 correspond to FIG. 4B or FIG. 4C. Note that part of components is omitted in FIG. 5. In addition, the manufacturing method illustrated in FIGS. 3A to 3E, FIGS. 4A to 4D, and FIG. 5 is only an example, and therefore, another manufacturing method may also be employed.

First, a conductive layer 202 serving as a gate electrode or a gate wiring (also referred to as a scan line) is selectively formed over a first substrate 200, and a gate insulating layer 204 and a semiconductor layer 206 are formed so as to cover the conductive layer 202 (see FIG. 3A).

The first substrate 200 can be made of glass, metal (typically stainless steel), ceramics, plastic, or the like. Here, a substrate formed of glass (a glass substrate) is used as the first substrate 200. Note that one embodiment of the disclosed invention is not limited thereto. Another substrate may also be used as long as a liquid crystal display device is realized.

Although not illustrated, a base layer is preferably formed over the first substrate 200. The base layer has a function of preventing diffusion of an impurity from the first substrate 200, such as an alkali metal (e.g., Li, Cs, or Na) or an alkaline earth metal (e.g., Ca or Mg). That is, provision of the base layer can achieve an object of improving the reliability of a semiconductor device. The base layer can be formed using one or more materials selected from silicon nitride, silicon oxide, silicon nitride oxide, silicon oxynitride, aluminum oxide, aluminum nitride, aluminum oxynitride, an aluminum nitride oxide, and the like. Note that the base layer may have a single-layer structure or a stacked-layer structure.

After formation of a conductive layer of a single-layer structure or a stacked-layer structure using a metal material such as aluminum (Al), tungsten (W), titanium (Ti), tantalum (Ta), molybdenum (Mo), nickel (Ni), platinum (Pt), copper (Cu), gold (Au), silver (Ag), manganese (Mn), neodymium (Nd), niobium (Nb), chromium (Cr), or cerium (Ce); an alloy material containing any of the above metal materials as its main component; or a nitride containing any of the above metal materials as its component, the conductive layer is selectively etched and the conductive layer 202 can be formed. Note that methods for forming the conductive layer include, but are not limited to, a vacuum evaporation method, a sputtering method, and the like. In this embodiment, a stacked-layer structure of titanium and aluminum is employed for the conductive layer 202.

The conductive layer 202 preferably has a tapered end portion so as to be favorably covered with the gate insulating layer 204, the semiconductor layer 206, and the like which are formed later, and to prevent disconnection. Formation of the conductive layer 202 as a tapered shape can thus achieve an object of improving the yield of the liquid crystal display device.

The gate insulating layer 204 can be formed of a single-layer structure or a stacked-layer structure using one or more materials selected from silicon oxide, silicon oxynitride, silicon nitride, silicon nitride oxide, aluminum oxide, aluminum nitride, aluminum oxynitride, an aluminum nitride oxide, tantalum oxide, and the like. For example, the gate insulating layer 204 may be formed by a sputtering method, a CVD method, or the like to a thickness of 20 nm to 200 nm, inclusive. Here, a silicon oxide film of 100 nm thick is formed as the gate insulating layer 204. Note that one embodiment of the disclosed invention is not limited thereto.

The semiconductor layer 206 can be formed using an inorganic semiconductor material such as silicon, gallium, or gallium arsenide; an organic material such as a carbon nanotube; a variety of oxide semiconductors such as an In—Ga—Zn—O-based oxide semiconductor material; a mixed material thereof; or the like. Those materials can be used in any of the states such as single crystalline, polycrystalline, microcrystalline, nano-crystalline, and amorphous. Note that formation methods of the above-described semiconductor layer include, but are not limited to, a CVD method, a sputtering method, and the like.

In this embodiment, the In—Ga—Zn—O-based oxide semiconductor material is used for formation of the semiconductor layer 206. Typical examples of oxide semiconductor materials include In—Ga—Zn—O-based, In—Sn—Zn—O-based, In—Al—Zn—O-based, Sn—Ga—Zn—O-based, Al—Ga—Zn—O-based, Sn—Al—Zn—O-based, In—Zn—O-based, Sn—Zn—O-based, Al—Zn—O-based, Zn—O-based oxide semiconductor materials, and the like.

For example, the semiconductor layer 206 formed using the In—Ga—Zn—O-based oxide semiconductor material can be formed by a sputtering method using an oxide semiconductor target containing In, Ga, and Zn (e.g., In₂O₃:Ga₂O₃:ZnO=1:1:1). The sputtering can be performed, for example, under the following conditions: the distance between the substrate 200 and the target is 30 mm to 500 mm; the pressure is 0.1 Pa to 2.0 Pa; the DC power source is 0.25 kW to 5.0 kW (when a target of 8-inch in diameter is used); and the atmosphere is an argon atmosphere, an oxygen atmosphere, or a mixed atmosphere of argon and oxygen. The thickness of the oxide semiconductor layer 206 may be approximately 5 nm to 200 nm.

The above sputtering method can be performed by an RF sputtering method in which a high frequency power source is used as a sputtering power source, a DC sputtering method, a pulsed DC sputtering method in which direct current bias is applied in pulses, or the like. Note that use of a pulsed direct current (DC) power supply is preferred because dust can be reduced and thickness distribution can be uniform. In this case, objects of improving the yield of a semiconductor device and reliability thereof can be achieved.

In this embodiment, the case where the oxide semiconductor material is used as the semiconductor layer 206 is described; however, one embodiment of the disclosed invention is not limited thereto. Any of the above-described various semiconductor materials can be used for formation of the semiconductor layer 206. With use of an oxide semiconductor material for the semiconductor layer 206, a transistor capable of high-speed operation can be formed through a simple process, and therefore, it is possible to provide a liquid crystal display device sufficiently making use of high speed of a blue-phase liquid crystal with a low cost.

Next, a resist mask 208 is formed over the semiconductor layer 206, and the semiconductor layer 206 is selectively etched using the resist mask 208 to form an island-shape semiconductor layer 210 (see FIG. 3B). Note that the semiconductor layer 210 serves as an active layer of the transistor.

The resist mask can be formed by a spin coating method, for example. It is also possible to use a droplet discharge method, a screen printing method, or the like. In these cases, the resist mask can be selectively formed, which can result in achieving an object of increasing the productivity.

Either wet etching or dry etching may be employed for etching the semiconductor layer 206. Here, an unnecessary portion of the semiconductor layer 206 is removed by wet etching using a mixed solution of acetic acid, nitric acid, and phosphoric acid, and the semiconductor layer 210 is formed. Note that the resist mask 208 is removed after the etching. In addition, an etchant (an etching solution) for the wet etching is not limited to the above solution as long as the semiconductor layer 206 can be etched.

In the case of dry etching, a gas containing fluorine or a gas containing chlorine is preferably used. The dry etching can be performed with use of an etching apparatus using a reactive ion etching method (an RIE method), or a dry etching apparatus using a high-density plasma source such as electron cyclotron resonance (ECR) or inductively coupled plasma (ICP). In addition, an enhanced capacitively coupled plasma (ECCP) mode etching apparatus, by which a larger area can be discharged uniformly as compared to the case of using the ICP etching apparatus, may also be used. The ECCP mode etching apparatus can be applied also to a case of using a substrate of the tenth generation or later.

In this embodiment, wet etching is employed and the semiconductor layer 210 is formed.

After removal of the resist mask 208, a conductive layer 212 is formed so as to cover the semiconductor layer 210 (see FIG. 3C). Here, the conductive layer 212 can be formed using a material similar to that of the conductive layer 202. That is, the conductive layer 212 can be formed using a metal material such as aluminum (Al), tungsten (W), titanium (Ti), tantalum (Ta), molybdenum (Mo), nickel (Ni), platinum (Pt), copper (Cu), gold (Au), silver (Ag), manganese (Mn), neodymium (Nd), niobium (Nb), chromium (Cr), or cerium (Ce); an alloy material containing any of the above metal materials as its main component; or a nitride containing any of the above metal materials as its component. Note that the conductive layer 212 may have a single-layer structure or a stacked-layer structure. In addition, a variety of methods can be employed for formation of the conductive layer 212, such as a vacuum evaporation method or a sputtering method, as in the case of the conductive layer 202. In this embodiment, a stacked-layer structure of titanium and aluminum is employed for the conductive layer 212.

Next, a resist mask 214a and a resist mask 214b are formed over the conductive layer 212, the conductive layer 212 is selectively etched using the resist mask 214a and the resist mask 214b, and a conductive layer 216a serving as a source electrode or a source wiring (also referred to as a signal line) and a conductive layer 216b serving as a drain wiring are formed (see FIG. 3D). Note that the resist mask 214a and the resist mask 214b are removed after the etching.

The resist mask 214a and the resist mask 214b can be formed in a manner similar to that of the resist mask 208. Either wet etching or dry etching may be employed for etching the conductive layer 212. In this embodiment, dry etching is employed. When dry etching is performed, a gas containing chlorine or a gas containing chlorine to which oxygen is added is preferably used, for example. The reason is that, with use of the gas containing chlorine and oxygen, etching selectivity of the conductive layer 212 and the semiconductor layer 206 can be obtained.

By the above-described dry etching, the conductive layer 212 is divided by a region 220 to form the conductive layer 216a and the conductive layer 216b. In addition, the semiconductor layer 210 in the region 220 is removed. Note that an insulating layer for stopping the etching process may be formed between the semiconductor layer 210 and the conductive layer 212. The insulating layer is formed in a region corresponding to the region 220.

In this embodiment, different resist masks are used for the etching of the semiconductor layer 206 and the etching of the conductive layer 212; however, one embodiment of the disclosed invention is not limited to this method. After the semiconductor layer 206 and the conductive layer 212 are stacked in order, a resist mask having a plurality of thicknesses may be used for etching the semiconductor layer 206 and the conductive layer 212. In this case, the semiconductor layer is left under the conductive layer. Note that the resist mask having a plurality of thicknesses can be formed by light-exposure with use of a multi-tone mask.

After the formation of the conductive layer 216a and the conductive layer 216b, it is preferred to perform thermal treatment at 200° C. to 600° C., typically 300° C. to 500° C. Here, the thermal treatment is performed at 350° C. for an hour in a nitrogen atmosphere. This thermal treatment can improve semiconductor characteristics of the semiconductor layer 210. Note that there is no particular limitation on the timing of the thermal treatment as long as it is after formation of the semiconductor layer 210. In addition, the thermal treatment may be performed in plural different times.

After removal of the resist mask 214a and the resist mask 214b, an insulating layer 222 is formed so as to cover the gate insulating layer 204, the semiconductor layer 210, the conductive layer 216a, the conductive layer 216b, and the like (see FIG. 3E). The insulating layer 222 can be formed of a single-layer structure or a stacked-layer structure using one or more materials selected from silicon oxide, silicon oxynitride, silicon nitride, silicon nitride oxide, aluminum oxide, aluminum nitride, aluminum oxynitride, an aluminum nitride oxide, tantalum oxide, and the like; a material including carbon such as diamond-like carbon (DLC); an organic material such as epoxy, polyimide, polyamide, polyvinylphenol, benzocyclobutene, or acrylic; a siloxane material such as siloxane resin; or the like. The insulating layer 222 can be formed by a variety of methods: a sputtering method, a CVD method, a spin coating method, a screen printing method, an inkjet method, or the like. Note that the material, the formation method, and the like of the insulating layer 222 are not limited to the above description. In addition, the insulating layer 222 is not necessarily formed. In this embodiment, a silicon oxide film formed by sputtering is used as the insulating layer 222.

Next, the insulating layer 222 is selectively etched for formation of an opening which reaches the conductive layer 216b, and a conductive layer 224 serving as a pixel electrode is selectively formed (see FIG. 4A). The conductive layer 224 can be formed by selectively etching a conductive layer using a light-transmitting conductive material such as indium oxide containing tungsten oxide, indium zinc oxide containing tungsten oxide, indium oxide containing titanium oxide, indium tin oxide containing titanium oxide, indium tin oxide (ITO), indium zinc oxide, or indium tin oxide to which silicon oxide is added. In the case of a liquid crystal display device using a horizontal electric field, or a reflective or transflective liquid crystal display device in which a light-transmitting property is not needed for a pixel electrode or a common electrode, an electrode material such as aluminum (Al), tungsten (W), titanium (Ti), tantalum (Ta), molybdenum (Mo), nickel (Ni), platinum (Pt), copper (Cu), gold (Au), silver (Ag), manganese (Mn), neodymium (Nd), niobium (Nb), chromium (Cr), cerium (Ce), or the like can be used as appropriate. A variety of methods can be used for formation of the conductive layer, such as a vacuum evaporation method or a sputtering method. In this embodiment, indium tin oxide is used for formation of the conductive layer 224.

Next, a first spacer layer 100 is formed over the first substrate 200 (see FIG. 4B and FIG. 5). The first spacer layer 100 can be formed by selectively etching an insulating layer formed over the first substrate 200. Materials of the insulating layer include the following: an organic resin material containing acrylic, polyimide, polyimide amide, epoxy, or the like as its main component; an inorganic material containing oxygen, nitrogen, silicon, and/or the like (e.g., silicon oxide, silicon nitride, silicon oxide containing nitrogen); or the like. Note that the formation method of the first spacer layer 100 is not limited to the description above. For example, a method for selectively forming an insulating layer, such as a screen printing method or an inkjet method may be employed so that the first spacer layer 100 is formed.

In this embodiment, the first spacer layer 100 is formed in the vicinity of the portion where the conductive layer 202 and the conductive layer 216a are crossed; however, one embodiment of the disclosed invention is not limited to this mode. Another mode can also be employed for the first spacer layer 100 as long as a predetermined cell thickness is secured by the first spacer layer 100.

After formation of the first spacer layer 100, an insulating layer 226 is formed so as to cover the insulating layer 222, the conductive layer 224, and the first spacer layer 100 (see FIG. 4C). The insulating layer 226 can be formed using a material and method which are similar to those of the insulating layer 222. Note that the insulating layer 226 is not a necessary component, and it can be omitted when unnecessary.

When an alignment film is needed, the insulating layer 226 may have a function as the alignment film, for example, by performing rubbing treatment on the insulating layer 226.

Next, the first substrate 200 provided with the above-described components and the second substrate 250 provided with the layer 290 including a common electrode (also referred to as a counter electrode), a second spacer layer 102, an insulating layer 292, and the like are bonded to each other with a sealant or the like (see FIG. 4D). The material of the second substrate 250 may be similar to that of the first substrate 200. Needless to say, materials of the first substrate 200 and the second substrate 250 may be different from each other. There is no particular limitation on the structure of the layer 290; in addition to the common electrode, a color filter, a black mask, a polarizing plate, or the like may also be provided. In the case of a liquid crystal display device using a horizontal electric field or the like, the layer 290 may have a structure without the common electrode. The second spacer layer 102 can be formed in a manner similar to that of the first spacer layer 100. The insulating layer 292 can be formed similarly to the insulating layer 226.

Next, a liquid crystal layer 260 is formed by injecting a liquid crystal material between the bonded first substrate 200 and the second substrate 250. After injection of the liquid crystal material, an inlet for injection is sealed with an ultraviolet curing resin or the like. Alternatively, after dropping the liquid crystal material over either the first substrate 200 or the second substrate 250, these substrates may be bonded to each other.

It is preferred that, for example, the liquid crystal material be a liquid crystal material exhibiting a blue phase, which is superior in a response time. The liquid crystal material exhibiting a blue phase preferably includes a chiral agent in addition to a liquid crystal. The blue phase can appear easily with the use of a liquid crystal material into which the chiral agent is mixed at 5 wt % or more, for example. In general, in the blue phase under a white display condition, the birefringence Δn is 0.05 or less and the Kerr coefficient is 1×10⁻⁹ mV⁻² or more, a required cell thickness is approximately 6 μm or more (preferably 10 μm or more). As a result, effects of one embodiment of the present invention are notable in the case of a liquid crystal display device using the blue phase. Note that the liquid crystal material is not limited to the above-described material. It is possible to select and use a liquid crystal material containing thermotropic liquid crystal, low molecular liquid crystal, high molecular liquid crystal, ferroelectric liquid crystal, anti-ferroelectric liquid crystal, or the like, as appropriate. In addition, there is no particular limitation on a liquid crystal phase to be used either; it is possible to use a cholesteric phase, a cholesteric blue phase, a smectic phase, a smectic blue phase, a cubic phase, a chiral nematic phase, an isotropic phase, or the like, as appropriate.

Through the above steps, a liquid crystal display device is completed.

As described in this embodiment, with the use of the first spacer layer provided for the first substrate and the second spacer layer provided for the second substrate, it is possible to provide a liquid crystal display device in which a cell thickness of 6 μm or more (preferably, 10 μm or more) is secured. As a result, display characteristics can be improved also in a liquid crystal display device whose cell thickness needs to be large (e.g., a liquid crystal display device using a blue phase with a birefringence Δn of 0.05 or less under the white display condition, or a liquid crystal display device whose liquid crystal layer has a Kerr coefficient of 1×10⁻⁹ mV⁻² or more).

The structures, methods, or the like described in this embodiment can be implemented in combination with another structure, method, or the like described in another embodiment, as appropriate.

### Embodiment 3

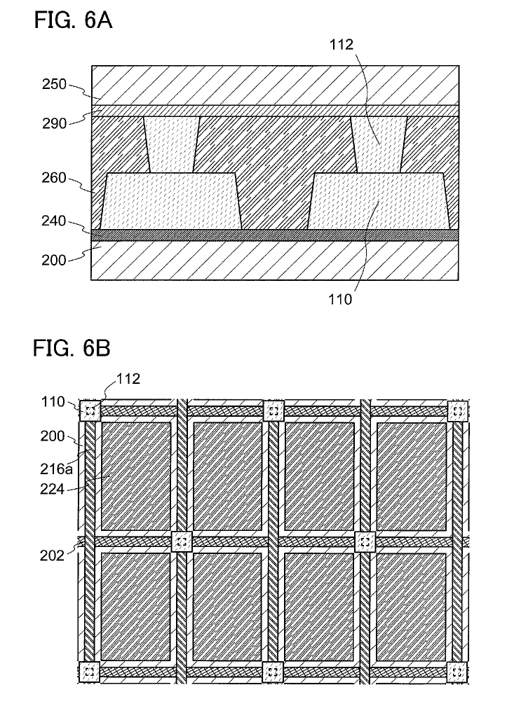

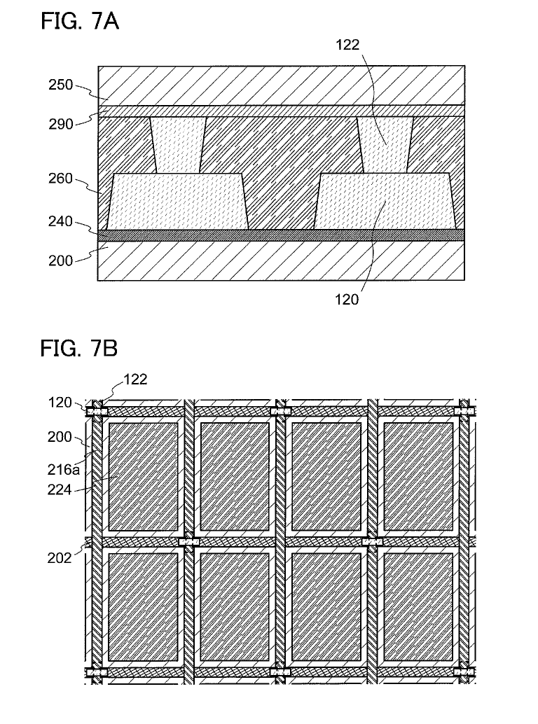

In this embodiment, a liquid crystal display device which is another embodiment of the disclosed invention is described with reference to FIGS. 6A and 6B and FIGS. 7A and 7B. Note that the structures illustrated in FIGS. 6A and 6B and FIGS. 7A and 7B are only examples, and therefore, another structure may also be employed.

FIG. 6A and FIG. 7A are cross-sectional schematic views of the liquid crystal display device which is one embodiment of the present invention. FIG. 6B and FIG. 7B are plan schematic views of the liquid crystal display device.

Difference between the liquid crystal display device described in this embodiment and the liquid crystal display device (see FIGS. 1A and 1B) described in any of the foregoing embodiments is the size and shape of a first spacer layer 100, the size and the shape of a second spacer layer 102, or the like. The details of the other structures are omitted here because any of the foregoing embodiments can be referred to.

FIGS. 6A and 6B illustrate a liquid crystal display device having a first spacer layer 110, which is larger than that of the foregoing embodiments. By making the first spacer layer larger, alignment precision can be less required when a first substrate 200 and a second substrate 250 are bonded to each other. The productivity of the liquid crystal display device can be thus increased. A second spacer layer 112 provided for the second substrate 250 is illustrated by dashed lines in FIG. 6B for understanding of the invention. Here, the size of the second spacer layer 112 is substantially the same as that of the second spacer layer 102 in FIGS. 1A and 1B.

Note that the size or the like of the spacer layers is not limited to the description above. Another mode can also be employed which increases the productivity, and the size of the spacer layers or the like may be modified as appropriate. For example, the second spacer layer 112 can be larger and the first spacer layer 110 in FIGS. 6A and 6B can be substantially as large as the first spacer layer 100 in FIGS. 1A and 1B. Needless to say, both the first spacer layer 110 and the second spacer layer 112 may be larger.

In the description above, making the spacer layer larger means making a surface area of the first spacer layer (or the second spacer layer) including a region in contact with the second spacer layer (or the first spacer layer) larger, and does not always include the other meanings. For example, there is no particular limitation on the height of the spacer layer; it may be larger or smaller.

Since the productivity can be increased by making either the first spacer layer 110 or the second spacer layer 112 larger, the relation between the first spacer layer and the second spacer layer can be referred to as follows: a surface area of the first spacer layer (or the second spacer layer) including a region in contact with the second spacer layer (or the first spacer layer) is larger than a surface area of the second spacer layer (or the first spacer layer) including a region in contact with the first spacer layer (or the second spacer layer).

FIGS. 7A and 7B illustrate a liquid crystal display device having a first spacer layer 120 and a second spacer layer 122 whose shape is different from that of the spacer layers of the foregoing embodiments. By changing the shape of the first spacer layer and the second spacer layer, alignment precision can be less required when the first substrate 200 and the second substrate 250 are bonded to each other. The productivity of the liquid crystal display device can be thus increased. The second spacer layer 122 provided for the second substrate 250 is illustrated by dashed lines in FIG. 7B for understanding of the invention. Here, the first spacer layer 120 (or the second spacer layer 122) is formed so as to be a rectangle or an approximate rectangle when seen from a direction perpendicular to a main surface of the first substrate 200 (or a main surface of the second substrate 250). In addition, the first spacer layer 120 and the second spacer layer 122 are formed so as to cross respective long sides (long sides of the above-described rectangles).

Note that the shape or the like of the spacer layer is not limited to the description above. Another mode can also be employed which increases the productivity, and the shape of the spacer layer or the like may be modified as appropriate. For example, the first spacer layer 120 can have the shape and size similar to those of the first spacer layer 110 in FIGS. 6A and 6B. Needless to say, the shape of the first spacer layer 120 and the second spacer layer 122 is not limited to the rectangular or the approximate rectangular, but can be a variety of shapes; for example, a polygon such as triangle, square, or pentagon, a circle, an ellipse, or the like can also be employed.

It is preferred that fluidity of a liquid crystal is not decreased as much as possible by the size and shape of the spacer layers. For example, although it is possible to employ a structure in which the spacer layer 120 in FIGS. 7A and 7B are extended in the long-side direction to be in contact with an adjacent spacer layer 120, in such cases employing this structure, the spacer layer decreases the fluidity of a liquid crystal, and injection of a liquid crystal material can take a long time in some cases depending on the viscosity of the liquid crystal, which can result in a lower productivity. In order not to cause such a problem, it is preferred to employ a size and shape of the spacer layers which decrease the fluidity of a liquid crystal as little as possible.

For example, since the viscosity of liquid crystal materials which exhibit a blue phase is approximately 1 Pa·sec to 10 Pa·sec (typically 3 Pa·sec at 25° C.), considering the time for injection of a liquid crystal material, a maximum width of the spacer layer (for example, a length in the long-side direction) is preferably less than the length in the short-side direction of a pixel. That is, even in the case where a spacer layer is provided by pixels which are adjacent to each other, the length of the spacer layer is not so long that the spacer layer is not in contact with another adjacent spacer layer. For example, when a pixel has a size of approximately 100 μm×30 μm, the maximum width of the spacer layer may be less than approximately 30 pm. With such a structure, an increase of the time for injection of a liquid crystal can be suppressed. That is, an object of increasing the productivity can be achieved. Because of difficulty in making a minimum width of the spacer layer (for example, a length in the short-side direction) shorter than the height of the spacer layer in consideration of a manufacturing process, the minimum width of the spacer layer is preferably longer than or equal to the height of the spacer layer. For example, when the spacer layer is 3 μm high, the minimum width of the spacer layer may be longer than or equal to 3 μm.

As described in this embodiment, in one embodiment of the disclosed invention, with the use of the first spacer layer provided for the first substrate and the second spacer layer provided for the second substrate, it is possible to provide a liquid crystal display device in which a cell thickness of 6 μm or more (preferably, 10 μm or more) is secured. As a result, display characteristics can be improved also in a liquid crystal display device whose cell thickness needs to be large (e.g., a liquid crystal display device using a blue phase).

In addition, as described in this embodiment, by modifying the size and shape of the first spacer layer and the second spacer layer, the productivity of the liquid crystal display device can be increased. This effect is particularly notable in the case of using a liquid crystal material with high viscosity (for example, a liquid crystal material exhibiting a blue phase and whose viscosity is approximately 1 Pa·sec to 10 Pa·sec) or the like.

The structures, methods, or the like described in this embodiment can be implemented in combination with another structure, method, or the like described in another embodiment, as appropriate.

### Embodiment 4

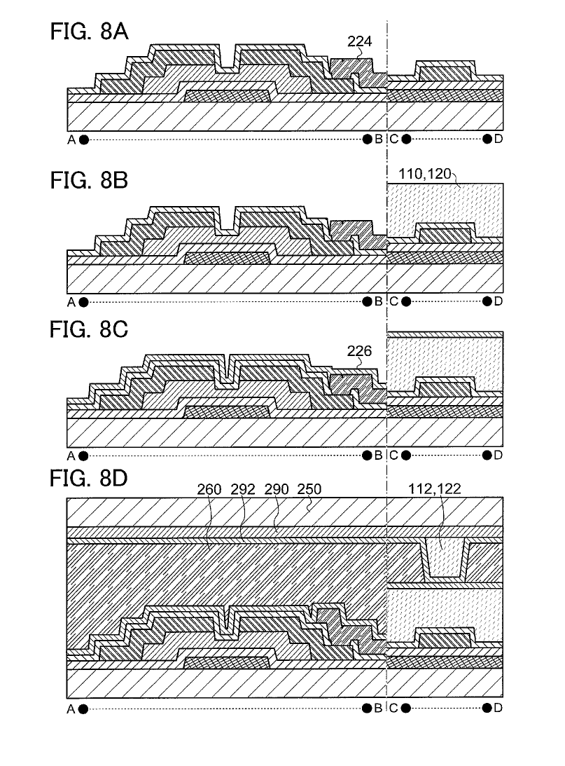

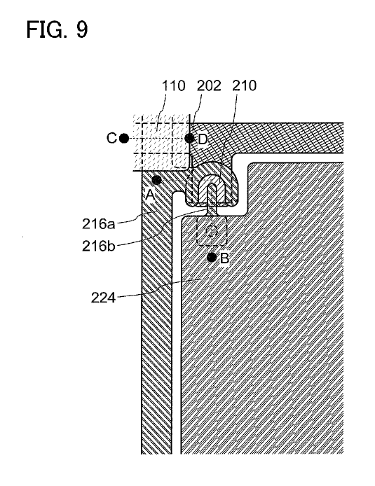

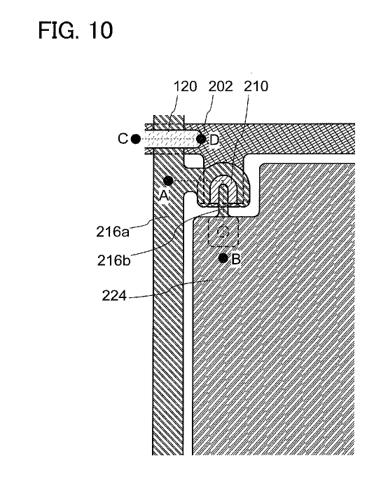

In this embodiment, a method for manufacturing a liquid crystal display device which is another embodiment of the disclosed invention is described with reference to FIGS. 8A to 8D, FIG. 9, and FIG. 10. Here, cross sections taken along lines A-B and C-D in FIG. 9 and FIG. 10 correspond to FIG. 8B or FIG. 8C. Note that part of components is omitted in FIG. 9 and FIG. 10. In addition, a manufacturing method illustrated in FIGS. 8A to 8D, FIG. 9, and FIG. 10 is only an example, and therefore, another manufacturing method may also be employed.

A large number of parts of the manufacturing method described in this embodiment are the same as those described in any of the foregoing embodiments. Description of the same parts is therefore omitted in this embodiment.

First, a condition illustrated in FIG. 3E is prepared by a method described in any of the foregoing embodiments or the like. Next, an insulating layer 222 is selectively etched for formation of an opening which reaches a conductive layer 216b, and a conductive layer 224 serving as a pixel electrode is selectively formed (see FIG. 8A). Any of the foregoing embodiments can be referred to for the details of the conductive layer 224.

Next, a first spacer layer 110 (or a first spacer layer 120) is formed over a first substrate 200 (see FIG. 8B, FIG. 9, and FIG. 10). Any of the foregoing embodiments can be referred to for the details of the first spacer layer 110. Here, the first spacer layer 110 (or the first spacer layer 120) having a different size or shape from that of the foregoing embodiments is formed.

After formation of the first spacer layer 110 (or the first spacer layer 120), an insulating layer 226 is formed so as to cover the insulating layer 222, the conductive layer 224, the first spacer layer 110 (or the first spacer layer 120) (see FIG. 8C). Any of the foregoing embodiments can be referred to for the details of the insulating layer 226.

Next, the first substrate 200 provided with the above-described components and a second substrate 250 provided with a layer 290 including a common electrode (also referred to as a counter electrode), a second spacer layer 112 (or a second spacer layer 122), an insulating layer 292, and the like are bonded to each other with a sealant or the like (see FIG. 8D). Any of the foregoing embodiments can also be referred to for the details of this step.

Next, a liquid crystal layer 260 is formed by injecting a liquid crystal material between the bonded first substrate 200 and the second substrate 250. After injection of the liquid crystal material, an inlet for injection is sealed with an ultraviolet curing resin or the like. Alternatively, after dropping the liquid crystal material over either the first substrate 200 or the second substrate 250, these substrates may be bonded to each other. Through the above steps, a liquid crystal display device is completed.

As described in this embodiment, with the use of the first spacer layer provided for the first substrate and the second spacer layer provided for the second substrate, it is possible to provide a liquid crystal display device in which a cell thickness of 6 μm or more (preferably, 10 μm or more) is secured. As a result, display characteristics can be improved also in a liquid crystal display device whose cell thickness needs to be large (e.g., a liquid crystal display device using a blue phase).

In addition, as described in this embodiment, by modifying the size and shape of the first spacer layer and the second spacer layer, productivity of the liquid crystal display device can be increased. This effect is particularly notable in the case of using a liquid crystal material with high viscosity (for example, a liquid crystal material exhibiting a blue phase and whose viscosity is approximately 1 Pa·sec to 10 Pa·sec) or the like.

The structures, methods, or the like described in this embodiment can be implemented in combination with another structure, method, or the like described in another embodiment, as appropriate.

### Embodiment 5

In this embodiment, examples of a liquid crystal display device are described. Note that the liquid crystal display device in this specification and the like includes the following modules or the like: a module to which a connector such as a flexible printed circuit (FPC), tape automated bonding (TAB) tape, or a tape carrier package (TCP) is attached; a module having a TAB tape or a TCP which is provided with a printed wiring board at the end thereof; and a module having an integrated circuit (IC) directly mounted on a substrate provided with a display element by a chip on glass (COG) method.

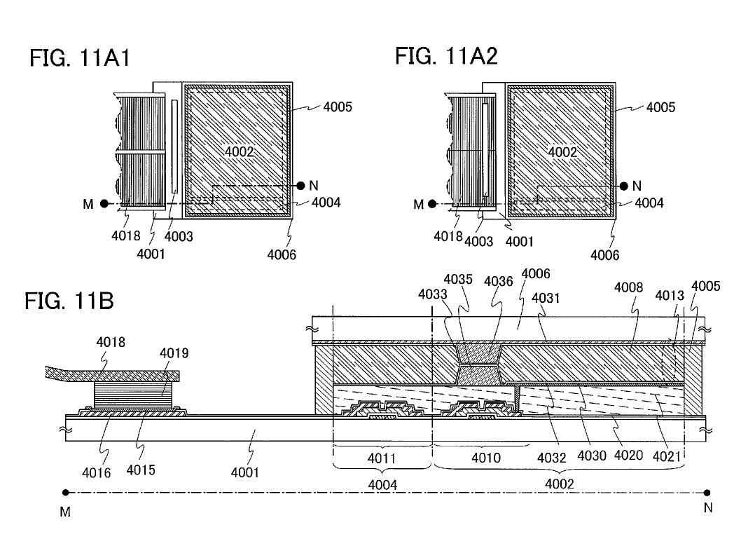

First, an external view and a cross section of a liquid crystal display panel are described with reference to FIGS. 11A1, 11A2, and 11B. FIGS. 11A1 and 11A2 are plan views of a panel in which a thin film transistor 4010, a thin film transistor 4011, and a liquid crystal element 4013 are sealed between a first substrate 4001 and a second substrate 4006 with a sealant 4005. FIG. 11B is a cross-sectional view taken along line M-N of FIGS. 11A1 and 11A2.

A signal line driver circuit 4003 which is formed using a single crystal semiconductor or a polycrystalline semiconductor over a substrate separately prepared is mounted in a region different from a region surrounded by the sealant 4005 over the first substrate 4001. Note that there is no particular limitation on the connection method of a driver circuit which is separately formed, and a COG method, a wire bonding method, a TAB method, or the like can be used as appropriate. FIG. 11A1 illustrates an example of mounting the signal line driver circuit 4003 by a COG method, and FIG. 11A2 illustrates an example of mounting the signal line driver circuit 4003 by a TAB method.

A plurality of thin film transistors are included in a pixel portion 4002 and a scan line driver circuit 4004, which are formed over the first substrate 4001. Note that FIG. 11B exemplifies the thin film transistor 4010 included in the pixel portion 4002 and the thin film transistor 4011 included in the scan line driver circuit 4004. An insulating layer 4020 and an insulating layer 4021 are provided over the thin film transistors 4010 and 4011.

For example, a thin film transistor using an In—Ga—Zn—O-based semiconductor can be used in the thin film transistor 4010 or the thin film transistor 4011. Needless to say, one embodiment of the disclosed invention is not limited thereto. The thin film transistor can be formed using a semiconductor including silicon or gallium, an organic semiconductor, or the like. Note that the thin film transistor 4010 and the thin film transistor 4011 are n-channel thin film transistors in this embodiment.

A pixel electrode layer 4030 included in the liquid crystal element 4013 is electrically connected to the thin film transistor 4010. The second substrate 4006 is provided with a counter electrode layer 4031 of the liquid crystal element 4013. A portion where the pixel electrode layer 4030, the counter electrode layer 4031, and the liquid crystal layer 4008 overlap with one another corresponds to the liquid crystal element 4013. Note that an insulating layer 4032 and an insulating layer 4033 are provided on a surface of the pixel electrode layer 4030 and the counter electrode layer 4031, respectively. The insulating layer 4032 and the insulating layer 4033 may have a function as an alignment film. Note that one embodiment of the disclosed invention is not limited to the above-described structure. For example, in the case of a liquid crystal display device using a horizontal electric field, both the pixel electrode layer and the counter electrode layer may be formed on the first substrate 4001 side.

It is possible to use a substrate made of glass, metal (typically stainless steel), ceramics, plastic, or the like as the first substrate 4001 and the second substrate 4006. As an example of plastic, a fiberglass-reinforced plastic (FRP) plate, a polyvinyl fluoride (PVF) film, a polyester film, an acrylic resin film, or the like can be used. Alternatively, a sheet in which aluminum foil is interposed between PVF films or polyester films, or the like may be used.

A columnar spacer layer 4035 and a columnar spacer layer 4036, which are obtained by selectively etching insulating films, are provided for the first substrate 4001 and the second substrate 4006, respectively. These spacer layers have a function of controlling a distance (a cell thickness) between the pixel electrode layer 4030 and the counter electrode layer 4031. With use of such two spacer layers in one embodiment of the disclosed invention, securing a desired cell thickness becomes easy.

The counter electrode layer 4031 is electrically connected to a common potential line formed over the same substrate as the thin film transistor 4010. With use of the common connection portion, the counter electrode layer 4031 and the common potential line can be electrically connected to each other through a conductive particle arranged between the pair of substrates. Note that the conductive particle is preferably contained in the sealant 4005.

For example, a liquid crystal exhibiting a blue phase is preferably used for a liquid crystal layer 4008. The blue phase is a liquid crystal phase and has a characteristic of an extremely high response time. Because the blue phase appears only in a small temperature range, it is preferred that a liquid crystal composition in which greater than or equal to 5 wt % of a chiral agent is mixed be used for the liquid crystal layer 4008 in order to improve the temperature range. The liquid crystal composition which includes a liquid crystal exhibiting the blue phase and a chiral agent have such characteristics that the response time is as short as 10 μs to 100 μs (the response time is extremely high), the alignment process is unnecessary because the liquid crystal composition has optical isotropy, and viewing angle dependency is small. Note that one embodiment of the disclosed invention is not limited thereto. A liquid crystal phase other than the blue phase may also be used.

Although a transmissive liquid crystal display device is described in this embodiment, an embodiment of the present invention can also be applied to a reflective liquid crystal display device or a transflective liquid crystal display device in which the transmissive type and the reflective type are combined. In addition, a polarizing plate may be provided on the outer side of the substrate (on the viewer side) or on the inner side. The same can be applied to a coloring layer. Further, a black mask (a black matrix) having a light-shielding function may be provided.

Although this embodiment shows a structure in which the insulating layer 4020 and the insulating layer 4021 cover thin film transistors in order that unevenness of a surface on which the pixel electrode layer 4030 is formed is reduced to improve display characteristics and to improve reliability of the thin film transistors, one embodiment of the disclosed invention is not limited thereto. Note that the insulating layer 4020 preferably has a function of preventing entry of a contaminant impurity from the outside and that the insulating layer 4021 preferably has a function of planarizing a surface on which the pixel electrode layer 4030 is formed.

More specifically, it is preferred that the insulating layer 4020 be a dense film. For example, the insulating layer may be formed by a sputtering method or a CVD method so as to have a single-layer structure or a stacked-layer structure of a silicon oxide film, a silicon nitride film, a silicon oxynitride film, a silicon nitride oxide film, an aluminum oxide film, an aluminum nitride film, an aluminum oxynitride film, an aluminum nitride oxide film, or the like. Note that the structure of the insulating layer 4020 is not limited to the above-described structure.

In addition, the insulating layer 4021 can be formed using an organic material having heat resistance such as polyimide, acrylic, benzocyclobutene, polyamide, or epoxy. Instead of such organic materials, it is also possible to use a low-dielectric constant material (a low-k material), a siloxane-based resin, PSG (phosphosilicate glass), BPSG (borophosphosilicate glass), or the like. Note that the insulating layer 4021 may be formed by stacking a plurality of insulating films formed using these materials.

The pixel electrode layer 4030 and the counter electrode layer 4031 can be formed using a light-transmitting conductive material such as indium oxide containing tungsten oxide, indium zinc oxide containing tungsten oxide, indium oxide containing titanium oxide, indium tin oxide containing titanium oxide, indium tin oxide (ITO), indium zinc oxide, indium tin oxide to which silicon oxide is added, or the like.

A conductive composition containing a conductive high molecule (also referred to as a conductive polymer) may also be used for the pixel electrode layer 4030 and the counter electrode layer 4031. The pixel electrode layer or the counter electrode layer which is formed using the conductive composition preferably have a sheet resistance of 1.0×10⁴ Ω/sq. or less and a transmittance of 70% or more at a wavelength of 550 nm. Further, the resistivity of the conductive high molecule included in the conductive composition is preferably less than or equal to 0.1 Ω·cm.

As the conductive high molecule, a so-called π-electron conjugated conductive polymer can be used. For example, polyaniline or a derivative thereof, polypyrrole or a derivative thereof, polythiophene or a derivative thereof; a copolymer of more than two kinds of these materials, or the like can be used.

A variety of signals are supplied from an FPC 4018 to the signal line driver circuit 4003, the scanning line driver circuit 4004, the pixel portion 4002, or the like, which are separately formed. A terminal included in the FPC 4018 is electrically connected to a connecting terminal electrode 4015 through an anisotropic conductive film 4019. In this embodiment, a connecting terminal electrode 4015 is formed using the same conductive film as that of the pixel electrode layer 4030 included in the liquid crystal element 4013, and a terminal electrode 4016 is formed using the same conductive film as that of source and drain electrode layers of the thin film transistors 4010 and 4011.

Note that FIGS. 11A1, 11A2 and 11B illustrate an example in which the signal line driver circuit 4003 is separately formed and mounted on the first substrate 4001; however, the disclosed invention is not limited thereto. The scan line driver circuit may be separately formed and then mounted, or only part of the signal line driver circuit or part of the scan line driver circuit may be separately formed and then mounted.

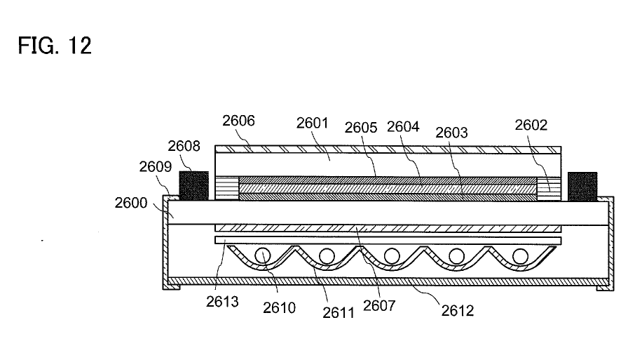

FIG. 12 illustrates an example of a liquid crystal display module which is formed using the above-described liquid crystal display panel.

The liquid crystal display module includes a first substrate 2600 and a second substrate 2601 which are fixed to each other with a sealant, and an element portion 2603 including a thin film transistor and the like, a liquid crystal layer 2604 including a liquid crystal, a coloring layer 2605, and the like are provided between the substrates. In addition, the first substrate 2600 and the second substrate 2601 are provided with a polarizing plate 2606, a polarizing plate 2607, respectively. The coloring layer 2605 is necessary to perform color display. In order to perform RGB display, coloring layers for red, green, and blue are provided for respective pixels. In addition to the polarizing plate 2607, a diffusion plate 2613 and the like are provided on the outer side of the first substrate 2600. A light source includes a cold cathode tube 2610 and a reflective plate 2611. A circuit substrate 2612 includes a control circuit, a power supply circuit, and the like, and is connected to a wiring circuit portion 2608 of the first substrate 2600 through a flexible wiring board 2609. A retardation plate may be provided between the polarizing plate and the liquid crystal layer.

In addition, the following can be employed as a diving method of a liquid crystal: a TN (twisted nematic) mode, an IPS (in-plane-switching) mode, an FFS (fringe field switching) mode, an MVA (multi-domain vertical alignment) mode, a PVA (patterned vertical alignment) mode, an ASM (axially symmetric aligned microcell) mode, an OCB (optical compensated birefringence) mode, an FLC (ferroelectric liquid crystal) mode, an AFLC (anti-ferroelectric liquid crystal) mode, a cholesteric liquid crystal mode, a PDLC (polymer dispersed liquid crystal) mode, a PNLC (polymer network liquid crystal) more, or the like.

As described above, since one embodiment of the disclosed invention can secure a desired cell thickness (the thickness of a liquid crystal layer), it is possible to provide a liquid crystal display device having superior display characteristics.

The structures, methods, or the like described in this embodiment can be implemented in combination with another structure, method, or the like described in another embodiment, as appropriate.

### Embodiment 6

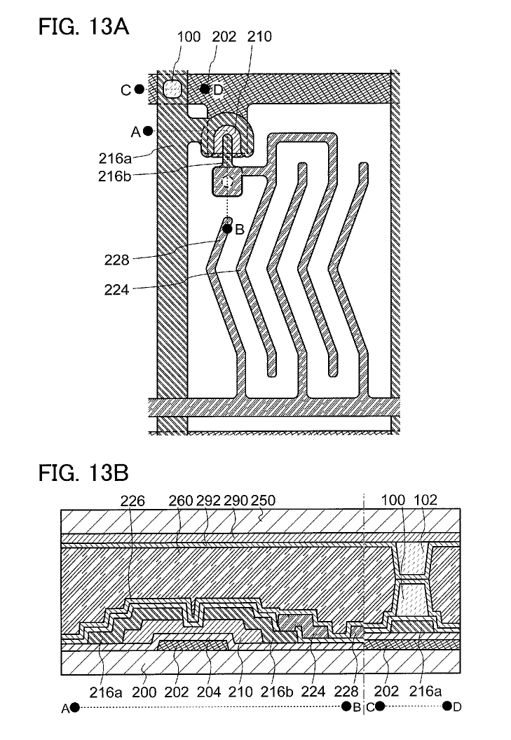

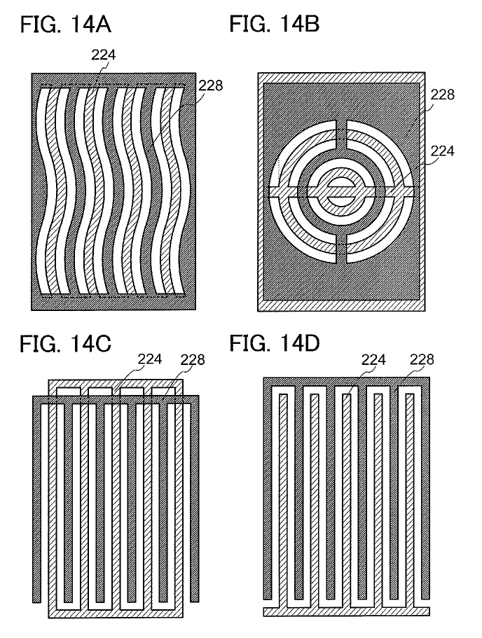

In this embodiment, a liquid crystal display device which is another embodiment of the disclosed invention is described with reference to FIGS. 13A and 13B and FIGS. 14A to 14D. Here, cross-sections taken along lines A-B and C-D in FIG. 13A correspond to FIG. 13B. Note that part of components is omitted in FIG. 13A.

A basic structure and a manufacturing process are omitted because they are similar to those described in any of the foregoing embodiments. The liquid crystal display device described in this embodiment is provided with a conductive layer 228 serving as a common electrode on a first substrate 200 side, and is different from the liquid crystal display device described in any of the foregoing embodiments in that an electric field generates in a horizontal direction (a direction which is approximately parallel to a main surface of the first substrate 200) between a conductive layer 224 serving as a pixel electrode and the conductive layer 228.

The conductive layer 228 can be formed together with a conductive layer 224. Alternatively, the conductive layer 228 may be formed together with a conductive layer 202. Similarly, it can be formed when a conductive layer 216a or a conductive layer 216b is formed. In this embodiment, a case where the conductive layer 228 is formed similarly to the conductive layer 224 is described; however, one embodiment of the disclosed invention is not limited thereto. The description of the step for forming each conductive layer can be referred to for more details. It is unnecessary to form a common electrode on a second substrate 250 side in the liquid crystal display device using a horizontal electric field described in this embodiment. For that reason, a common electrode is not included in a layer 290 in this embodiment.

In this embodiment, the conductive layer 224 and the conductive layer 228 are alternately placed; however, one embodiment of the disclosed invention is not limited to this arrangement. FIGS. 14A to 14D illustrate examples of electrode shapes which can be applied to a liquid crystal display device using a horizontal electric field. Note that the conductive layer 224 and the conductive layer 228 illustrated in FIGS. 14A to 14D may be interchanged. In addition, the electrode shape which can be used is not limited to these examples. In the case of the electrode shapes like FIGS. 14A, 14B, and 14C, since the conductive layer 224 and the conductive layer 228 partly overlap with each other, it is preferred that the conductive layer 224 and the conductive layer 228 be formed of different layers.

As described in this embodiment, with the use of the first spacer layer provided for the first substrate and the second spacer layer provided for the second substrate, it is possible to provide a liquid crystal display device in which a cell thickness of 6 μm or more (preferably, 10 μm or more) is secured. As a result, display characteristics can be improved also in a liquid crystal display device whose cell thickness needs to be large (e.g., a liquid crystal display device using a blue phase).

In addition, as described in this embodiment, by modifying the size and shape of the first spacer layer and the second spacer layer, productivity of the liquid crystal display device can be increased. This effect is particularly notable in the case of using a liquid crystal material with high viscosity (for example, a liquid crystal material exhibiting a blue phase) or the like.

The structures and methods described in this embodiment can be implemented in combination with another structure of method described in another embodiment, as appropriate.

This application is based on Japanese Patent Application serial no. 2009-057764 filed with Japan Patent Office on Mar. 11, 2009, the entire contents of which are hereby incorporated by reference.

What is claimed is:

1. A liquid crystal display device comprising:
a first substrate;
a second substrate;
a first spacer layer formed on the first substrate;
a second spacer layer formed on the second substrate; and
a liquid crystal layer including a liquid crystal between the first substrate and the second substrate,
wherein the first spacer layer and the second spacer layer are provided between the first substrate and the second substrate,
wherein at least a part of the second spacer layer overlaps with at least a part of the first spacer layer,
wherein a thickness of the liquid crystal layer is more than or equal to 6 μm, and
wherein a birefringence Δn of the liquid crystal layer under a white display condition is less than or equal to 0.05.

2. The liquid crystal display device according to claim 1, wherein a surface area of the first spacer layer including a region on the second spacer layer is larger than a surface area of the second spacer layer including a region on the first spacer layer.

3. The liquid crystal display device according to claim 1,
wherein the first spacer layer has a long side and a short side in a surface parallel to a main surface of the first substrate,
wherein the second spacer layer has a long side and a short side in a surface parallel to a main surface of the second substrate, and
wherein the long side of the first spacer layer crosses the long side of the second spacer layer.

4. The liquid crystal display device according to claim 3, wherein each length in long-side directions of the first spacer layer and the second spacer layer is shorter than a length in a short-side direction of a pixel.

5. The liquid crystal display device according to claim 1, wherein a blue phase is used as a liquid crystal phase of the liquid crystal layer.

6. The liquid crystal display device according to claim 1, wherein a pixel electrode and a common electrode are provided over the first substrate.

7. The liquid crystal display device according to claim 1 further comprising a scan line and a signal line between the first substrate and the first spacer layer.

8. The liquid crystal display device according to claim 1 further comprising a common electrode between the second substrate and the second spacer layer.

9. A liquid crystal display device comprising:
a first substrate;
a second substrate;
a first spacer layer formed on the first substrate;
a second spacer layer formed on the second substrate; and
a liquid crystal layer including a liquid crystal between the first substrate and the second substrate,
wherein the first spacer layer and the second spacer layer are provided between the first substrate and the second substrate,
wherein at least a part of the second spacer layer overlaps with at least a part of the first spacer layer,
wherein a thickness of the liquid crystal layer is more than or equal to 6 μm, and
wherein a Kerr coefficient of the liquid crystal layer is more than or equal to 1×10⁻⁹ mV⁻².

10. The liquid crystal display device according to claim 9, wherein a surface area of the first spacer layer including a region on the second spacer layer is larger than a surface area of the second spacer layer including a region on the first spacer layer.

11. The liquid crystal display device according to claim 9,
wherein the first spacer layer has a long side and a short side in a surface parallel to a main surface of the first substrate,
wherein the second spacer layer has a long side and a short side in a surface parallel to a main surface of the second substrate, and
wherein the long side of the first spacer layer crosses the long side of the second spacer layer.

12. The liquid crystal display device according to claim 11, wherein each length in long-side directions of the first spacer layer and the second spacer layer is shorter than a length in a short-side direction of a pixel.

13. The liquid crystal display device according to claim 9, wherein a blue phase is used as a liquid crystal phase of the liquid crystal layer.

14. The liquid crystal display device according to claim 9, wherein a pixel electrode and a common electrode are provided over the first substrate.

15. The liquid crystal display device according to claim 9 further comprising a scan line and a signal line between the first substrate and the first spacer layer.

16. The liquid crystal display device according to claim 9 further comprising a common electrode between the second substrate and the second spacer layer.

17. A liquid crystal display device comprising:
a first substrate;
a second substrate;
a first spacer layer formed on the first substrate;
a second spacer layer formed on the second substrate; and
a liquid crystal layer including a liquid crystal between the first substrate and the second substrate,
wherein the first spacer layer and the second spacer layer are provided between the first substrate and the second substrate,
wherein at least a part of the second spacer layer overlaps with at least a part of the first spacer layer,
wherein a thickness of the liquid crystal layer is more than or equal to 6 μm, and
wherein driving is performed by an electric field more than or equal to 3.0×10⁶ V/m under a white display condition.

18. The liquid crystal display device according to claim 17, wherein a surface area of the first spacer layer including a region on the second spacer layer is larger than a surface area of the second spacer layer including a region on the first spacer layer.

19. The liquid crystal display device according to claim 17,
wherein the first spacer layer has a long side and a short side in a surface parallel to a main surface of the first substrate,
wherein the second spacer layer has a long side and a short side in a surface parallel to a main surface of the second substrate, and
wherein the long side of the first spacer layer crosses the long side of the second spacer layer.

20. The liquid crystal display device according to claim 19, wherein each length in long-side directions of the first spacer layer and the second spacer layer is shorter than a length in a short-side direction of a pixel.

21. The liquid crystal display device according to claim 17, wherein a blue phase is used as a liquid crystal phase of the liquid crystal layer.

22. The liquid crystal display device according to claim 17, wherein a pixel electrode and a common electrode are provided over the first substrate.

23. The liquid crystal display device according to claim 17 further comprising a scan line and a signal line between the first substrate and the first spacer layer.

24. The liquid crystal display device according to claim 17 further comprising a common electrode between the second substrate and the second spacer layer.

25. A liquid crystal display device comprising:
a first substrate;
a second substrate;
a first spacer layer formed on the first substrate;
a second spacer layer formed on the second substrate; and
a liquid crystal layer including a liquid crystal between the first substrate and the second substrate,
wherein the first spacer layer and the second spacer layer are provided between the first substrate and the second substrate,
wherein at least a part of the second spacer layer overlaps with at least a part of the first spacer layer,
wherein a thickness of the liquid crystal layer is more than or equal to 6 μm,
wherein a birefringence Δn of the liquid crystal layer under a white display condition is less than or equal to 0.05,
wherein a Kerr coefficient of the liquid crystal layer is more than or equal to 1×10⁻⁹ mV⁻², and
wherein driving is performed by an electric field more than or equal to 3.0×10⁶ V/m under a white display condition.

26. The liquid crystal display device according to claim 25, wherein a surface area of the first spacer layer including a region on the second spacer layer is larger than a surface area of the second spacer layer including a region on the first spacer layer.

27. The liquid crystal display device according to claim 25,
wherein the first spacer layer has a long side and a short side in a surface parallel to a main surface of the first substrate,
wherein the second spacer layer has a long side and a short side in a surface parallel to a main surface of the second substrate, and
wherein the long side of the first spacer layer crosses the long side of the second spacer layer.

28. The liquid crystal display device according to claim 27, wherein each length in long-side directions of the first spacer layer and the second spacer layer is shorter than a length in a short-side direction of a pixel.

29. The liquid crystal display device according to claim 25, wherein a blue phase is used as a liquid crystal phase of the liquid crystal layer.

30. The liquid crystal display device according to claim 25, wherein a pixel electrode and a common electrode are provided over the first substrate.

31. The liquid crystal display device according to claim 25 further comprising a scan line and a signal line between the first substrate and the first spacer layer.

32. The liquid crystal display device according to claim 25 further comprising a common electrode between the second substrate and the second spacer layer.
